(19) United States
(12) Patent Application Publication
(10) Pub. No.: US 2008/0046201 A1
(43) Pub. Date: Feb. 21, 2008

(54) Coriolis Flowmeter

(75) Inventor: Matthias Roost, Arlesheim (CH)

Correspondence Address: BACON & THOMAS, PLLC, 625 SLATERS LANE, FOURTH FLOOR, ALEXANDRIA, VA, 22314, US

(73) Assignee: Endres + hauser Flowtec AG, Reinach (CH)

(21) Appl. No.: 10/557,847

(22) PCT Filed: May 18, 2004
(86) PCT No.: PCT/EP04/05314

§ 371 Date: Jan. 24, 2007

(30) Foreign Application Priority Data
May 19, 2003 (DE) 103 22 851.9

(51) Int. Cl. G01F 1/66

(52) U.S. Cl. 702/45

(57) ABSTRACT

A Coriolis flow measuring device having: At least one exciter system, which causes at least one measuring tube flowed-through by a medium to oscillate; a first measured value pickup which is provided in the region of the inlet of the measuring tube and which outputs an entrance signal; a second measured value pickup, which is arranged in the region of the outlet of the measuring tube and which outputs an exit signal; and a control/evaluation unit, which determines a phase displacement, or a difference of the phase angles, between the entrance signal and the exit via a CORDIC algorithm and which, on the basis of the calculated phase displacement, or on the basis of the calculated phase angle difference, determines mass flow rate, density and/or viscosity of the medium flowing in the measuring tube.

The invention relates to a Coriolis flow measuring device having: At least one exciter system, which causes at least one measuring tube flowed-through by a medium to oscillate; a first Oscillation pickup provided in the region of the intake of the measuring tube and issuing an entrance signal; a second oscillation pickup arranged in the region of the outlet of the measuring tube and issuing an exit signal; and a control/evaluation unit, which determines, on the basis of the entrance and exit signals, mass flow, e.g. mass flow rate, density and/or viscosity of the medium flowing through the measuring tube.

A Coriolis flow measurement is based, typically, on the measuring of two periodic oscillations, usually sinusoidal oscillations, which are picked-up in the region of the inlet (entrance signal) and the outlet (exit signal) of the measuring tube. The phase shift of the two oscillations is a measure of the mass flow rate (or density and/or viscosity) of the medium flowing through the measuring tube. The size of the difference of the phase angles between the two oscillation signals is directly proportional to the mass flow rate (or the density and/or viscosity) and lies in the micro-radian range.

The requirements for a suitable signal processing method are two. First of all, the very small phase angle must be determined as accurately as possible. Then, it must be assured that relatively cost-favorable computing infrastructures can be used for the processing. This is, in principle, only possible, when only a few calculating operations must be performed for determining the phase angle.

Often the two oscillation signals have interference, or disturbance, signals superimposed on them. Such interference signals arise, for example, from gas inclusions in the medium flowing through the measuring tube. In such case, the task is to extract the actual, wanted signal, under difficult conditions, from the oscillation signals, in order then to be able to perform the required phase determinations. Another significant boundary condition for extracting the pure oscillation signals from the interference-signal-burdened, entrance and exit signals is, moreover, to be seen in the processing time needed for a measurement. The smaller the processing time, the higher the rate of measurement can be, and, consequently, also the accuracy of measurement.

An object of the invention is to optimize the computing time needed for obtaining measured values in a Coriolis measuring device, compared with prior methods of signal evaluation, and effectively to suppress interference signals.

The object is achieved by having the control/evaluation unit determine the phase shift, or a difference of the phase angles between the entrance signal and the exit signal, via a CORDIC algorithm and determine the mass flow rate, density and/or viscosity of the medium flowing in the measuring tube on the basis of the calculated phase shift, or on the basis of the calculated phase angle difference.

CORDIC stands for Coordinate Rotation Digital Computing. By using the CORDIC algorithm, it is possible reliably to fulfill the above two requirements placed on a Coriolis measuring device. CORDIC is a numerical method, which e.g. permits, in the case of a Coriolis measuring device, direct determination of the current phase angle to any accuracy, using iterative computing steps. In principle, the CORDIC algorithm is used to perform a coordinate transformation of the oscillation signal Usch and the difference signal Udiff of the oscillating measuring tube into the sampling system, thus into the system of the two measured value pickups.

The advantages of the flow measuring device of the invention are multiple:

An advantage compared with conventional methods, such as, for example, the known quadrature-demodulation for the evaluation of Coriolis signals, lies in the saving of a filter stage at the output of the demodulation. This saving leads also to a fast processing of the signals and, therewith, to a time savings, which then can be used for a better suppression of interference signals.

Additionally, a CORDIC algorithm can be implemented very simply in a FPGA (=Field Programmable Gate Array) or in a Gate-Array-Chip. Also, multiplicative operations and the processing of trigonometric functions, which are very resource-intensive, can be effectively avoided. In this way, the basis for use of “Integrated Transmitters” is created, which introduce a considerable cost reduction.

CORDIC permits fixed-point implementation of the signal processing in a cost-favorable DSP or RISC-processor. Costly floating-point DSP hardware in not required.

CORDIC is very widely applicable for Coriolis measuring technology. On the one hand, the SW (software) of current DSP-systems can be optimized therewith—this representing a considerable cost-savings potential. On the other hand, the evaluation of conventional sum-, and difference-, signals can occur in a new, very simple manner. The use of a CORDIC algorithm offers, moreover, also the potential to evaluate the two oscillation signals directly, without analog sum/difference building, this, in turn, leading to a simplification of the method.

The CORDIC algorithm was first described in 1959 in the literature by Jack E. Volder. For a review of the CORDIC method, reference is made e.g. to the following paper: “A survey of CORDIC algorithms for FPGA based computers”, Ray Andraka, FPGA '98, Proceedings of the 1998 ACM/SIGDA 6th International Symposium on Field Programmable Gate Arrays, Feb. 22-24, 1998, Monterey, Calif. pp 191-200.

The state variable of a CORDIC processor is a complex number. This can be rotated by any angle in polar coordinates and then be output as a result. In such case, three essential instances of application result: Modulation, rotation and vectoring. p By modulation, a purely real input can be transformed into a complex number—the output corresponds then to the input modulated with sin(φ) and cos(φ). If the angle φ increases continuously with time and the real input X₀ is held constant, then the output sequence corresponds to a complex phasor of amplitude X₀·K_{q} and angle φ(t). If X₀ itself is a time-dependent signal, then the output corresponds to the quadrature-amplitude-modulated input signal.

In the case of rotation, the input is complex and the angle is predetermined and fixed; then, the output corresponds to a phasor rotated by the angle φ. If the input and the angle φ(t) are time-dependent, then the output sequence corresponds to a phase-modulated signal.

In the case of vectoring, the input is complex. Then, magnitude and phase can be determined by rotating the vector until the imaginary component Yₙ is zero. The output Xₙ then corresponds to the magnitude of (X₀, Y₀) and Zₙ then corresponds to the angle of (X₀, Y0).

In the case of the CORDIC algorithm, the angular rotation occurs iteratively, and, indeed, via a defined sequence of angular increments/decrements. CORDIC calculates only within a quadrant. Therefore, in a first step, the signs of X₀ and Y₀ are so modified, that the input (X_{0′}, Y_{0′}) comes to lie in the first quadrant. In the following, the state of the angle Zᵢ, as well as the quantities Xᵢ and Yᵢ, are iteratively changed according to the following method:

Xᵢ₊₁=Xᵢ−Yᵢ·dᵢ·2⁻ⁱ

Yᵢ₊₁=Yᵢ+Xᵢ·dᵢ·2⁻ⁱ

Zᵢ₊₁=Zᵢ−dᵢ·arctan(2⁻²)

The iteration terminates, depending on application, when the error of the approximated angle Zᵢ is sufficiently small relative to the desired angle of rotation, or, in the case of vectoring, when the imaginary component Yᵢ is sufficiently small. The accuracy is thus given by the number of cycles of iteration. Typically, an angular resolution of one bit is won per iteration.

The result of the CORDIC operation is the complex number (Xₙ, Yₙ)=Kᵢ·(Xᵢ, Yᵢ), i.e. the result is burdened with a factor K, which follows from the calculation rule. The result can be normalized with this factor or the matter can be cared for in later scalings.

$$\begin{matrix}{K}_{n} = {\prod }_{i = 0}^{n - 1} {K}_{i} \\ K i = cos ( arctan ( {2}^{- i} ) )\end{matrix}$$

The following are possibilities for implementation:

The angular increments, or angular decrements, as well as the CORDIC factor, can be calculated in advance for a predetermined number of iterations and stored in tables. The actual calculations then are composed of halving the state values X, Y and Z and their crossed-over summing, with appropriate signs. The halving of the state values can occur with a shift operation, while the summing occurs via a simple adder/subtractor. No multiplications or divisions, square-roots, or application of trigonometric operations are necessary.

An implementation into the software of a Coriolis flow measuring device is very easily possible, even without the presence of a math library. Because the CORDIC operations are limited to the first quadrant, also the range of the state variables X, Y and Z is limited.

An implementation in FPGA/ASIC hardware is especially advantageous, because no expensive multipliers need to be implemented. Depending on the required processing speed, bit-serial, or even parallel-pipelined, architectures are expedient, i.e., for each application, the most cost-favorable form can be selected. Depending on the selected number of iterations, processing accuracy can be easily controlled. Typically, for Coriolis signal processing, a Cordic co-process can be realized in hardware and, centered in a CPU, used for the calculation of a measured-value sample arbitrarily often. If also filter operations are implemented in co-process form in hardware too, then the DSP-CPU formerly typically used for Coriolis signal processing can be completely saved, i.e. only the specific operations for the Coriolis signal processing need to be implemented in hardware.

It is possible to implement the entire Coriolis signal evaluation (for reasons of cost) in a whole number, or integer, process, i.e. to completely avoid floating-point operations. Since multiplications are not used in the CORDIC algorithm, no exponentiated intermediate results arise. The hardware needed for state data, as measured in bits, can be held optimally within limits, and the intermediate scalings usual in the case of fixed point processing become significantly simpler.

In advantageous further developments of the device of the invention, the CORDIC algorithm can be applied for Coriolis signal processing equally in three different approaches:

a) Quadrature demodulation of the oscillation signal;

b) vectoring of the oscillation signal and rotation of the difference signal; and

c) vectoring of the entrance/exit oscillation signals.

The first two approaches use oscillation and difference signals, which are prepared by an analog frontend, which is already used today in the Coriolis flow measuring devices sold by the assignee. In the third approach, the entrance and exit oscillation signals are evaluated in parallel, independently of one another. Prerequisite for such an application is that present in the Coriolis flow measuring device is an analog frontend that can accurately maintain the phase relationships.

In the case of Approach a), a quadrature demodulation method is used for determining the amplitude of the oscillation signal, i.e. the oscillation signal is modulated with sine and cosine components of the same frequency, this leading to a folding of the oscillation signal into the baseband. For suppressing higher frequency components, the two components are each fed through a lowpass. From the stationary imaginary and real parts, the magnitude can be determined. With the known methods, it was long necessary to produce synthetically for the modulation sine and cosine oscillations, which were then applied to the oscillation signal via a multiplication. Both the production of the oscillations and the multiplications are avoided, when a CORDIC block is used in the modulation mode. The modulation frequency is input to the CORDIC block in the form of an angular increment.

For determining magnitudes, the known method requires squaring both the imaginary and real components, adding and taking the square root, which means a significant calculating burden. Using a CORDIC block in the vectoring mode, the magnitude can be ascertained directly from the imaginary and real components.

This approach makes sense, when separate blocks of the presently-used Coriolis signal processing of the assignee can be replaced by calculationally less intensive means. If the CORDIC block is realized in a FPGA, and a filter block, likewise implemented in FPGA, is available, then the current Coriolis signal processing breaks down into some few operations, which can be executed with the help of a commonly used RISC-CPU. A DSP-CPU can be avoided. This approach permits implementation in a single SOPC (System On Programmable Chip).

In the case of Approach b), a CORDIC block in vectoring mode is used for determining the magnitude of the oscillation signal. The vectoring-CORDIC block requires an analytic (complex) signal as input signal. This is produced from a bandpass filtering of the AD converter signals (for suppressing interference components) and a subsequent Hilbert allpass filtering. Thus, complex signals are produced from the real oscillation signal and the real difference signal. In order to determine an accurate mass flow rate through the measuring tube, the phasors of the oscillation signal and the difference signal must be brought into synchronous positions. In a first step for this, the difference signal is rotated by 90°, this being done in the case of complex signals simply by a switching of X and Y. The X input of the difference-signal CORDIC block is thus fed with the Hilbert component of the difference signal, while the Y-input is fed with the allpass component.

In case the analog amplification of the raw signals does not occur symmetrically, then the oscillation signal and difference signal still do not have the same phase position after the 90° rotation of the difference signal. Therefore, the difference-signal CORDIC-block is operated in rotation mode, and the difference signal is rotated by the current phase of the oscillation signal. In this way, the coordinate system of the difference signal is brought into the phase position of the oscillation signal. The remaining angle Z at the output of the difference-signal CORDIC-block then corresponds to the symmetry error. In order to control the symmetry, instead of the angle Z at the output X, also the real part of the difference signal referenced to the coordinate system of the oscillation signal can be used.

The output Y of the difference-signal CORDIC-block then shows exactly the imaginary part of the difference signal referenced to the coordinate system of the oscillation signal. This can be used together with the magnitude of the oscillation signal for calculating the mass flow rate.

From this, the following advantages are obtained: The oscillation signal magnitude and the imaginary part and the real part of the oscillation signal can be determined without multiplying. Since neither squaring nor dividing are necessary, the accuracy and resolution of the signals are better controllable, so that a cost-favorable, fixed-point approach becomes feasible. Additionally, the signal processing path is simplified overall.

In the case of Approach c), the two oscillation signals are digitized by a phase-true analog frontend without summing and difference formation. The digitizing occurs e.g. by using a single converter in multiplex operation. In the case of this method, each signal can subsequently be handled independently of the other. A CORDIC-block in the vectoring mode determines, for each oscillation signal, the present phase position and magnitude of the particular oscillation. Since the CORDIC blocks are able to resolve the phase position to any arbitrary degree of accuracy, the two Z-results of the CORDIC blocks are combinable for determining mass flow rate, i.e. the difference of the two phase positions is directly proportional to the mass flow rate being sought. Additionally, the angular increment of a signal is proportional to the frequency and thus to the density being sought for the medium flowing in the measuring tube.

Moreover, the magnitudes of the signals, which are yielded, so-to-say, as a by-product of the CORDIC algorithm, can be used for amplitude control. Since the phase positions of the immediate signals is known, frequency control can be implemented in simple manner.

The signal processing is significantly simplified yet further in the case of this approach. Therefore, this approach can be used for a minimum cost system. Thus, in the extreme case, not even a CPU is needed, in order to evaluate the signals. Particularly, a one-chip solution can be used in the low-cost range. For improving interference resistance, this approach likewise offers significant advantages. The entrance oscillation signal and the exit oscillation signal can be handled separately from one another; therefore, also the interference signals superimposed on these signals can be separately registered and eliminated. Moreover, the demands on the oscillation pickups on the measuring tube can be relaxed, sine the oscillation amplitudes no longer have to be equally large. Therefore, symmetry control in the analog frontend is avoided. The two oscillation signals can be treated completely independently of one another.

The invention will now be explained in greater detail on the basis of the appended drawings, the figures of which show as follows:

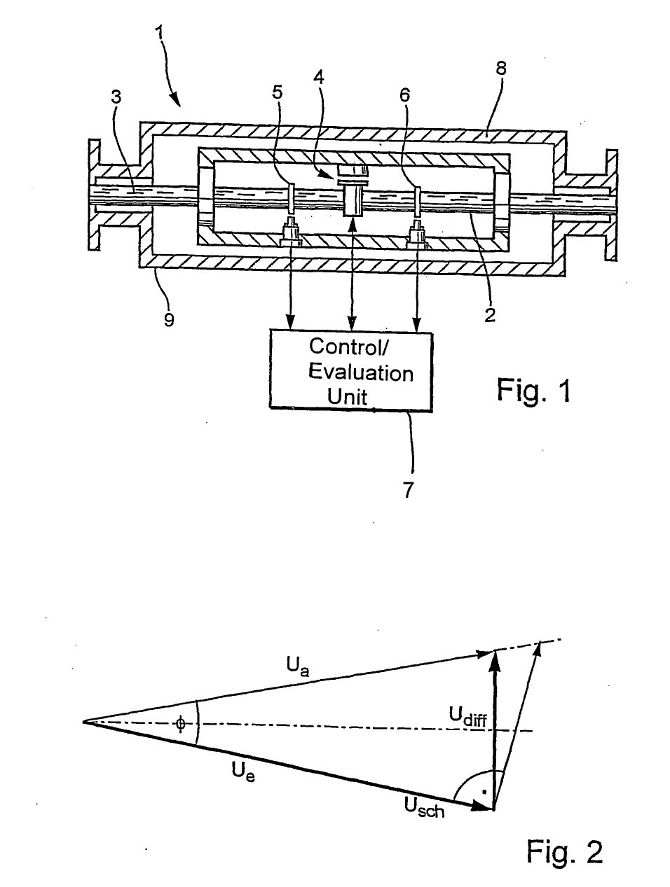

FIG. 1 a schematic drawing of a Coriolis flow measuring device 1 of the invention;

FIG. 2 a phasor diagram of the oscillation signal and the difference signal, which are both used for evaluating the signals of a Coriolis flow measuring device;

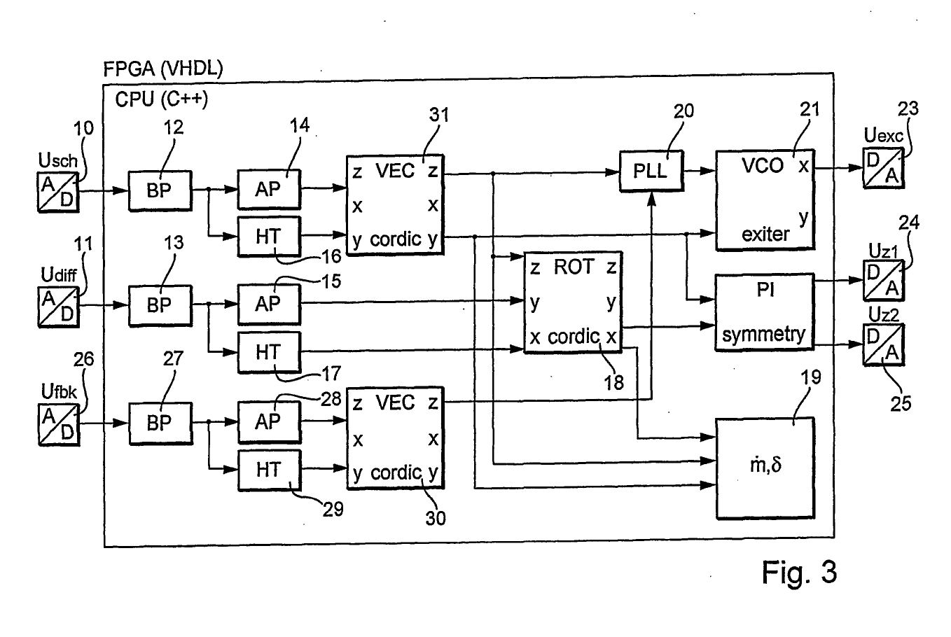

FIG. 3 a block diagram of a preferred embodiment (Approach b)) of the apparatus of the invention;

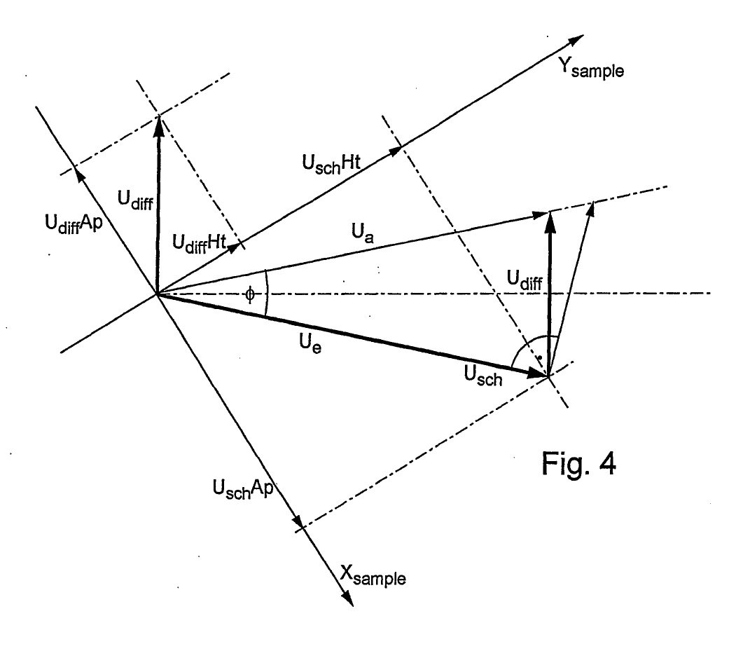

FIG. 4 a phasor diagram, which shows the analytic signal projection according to Approach b);

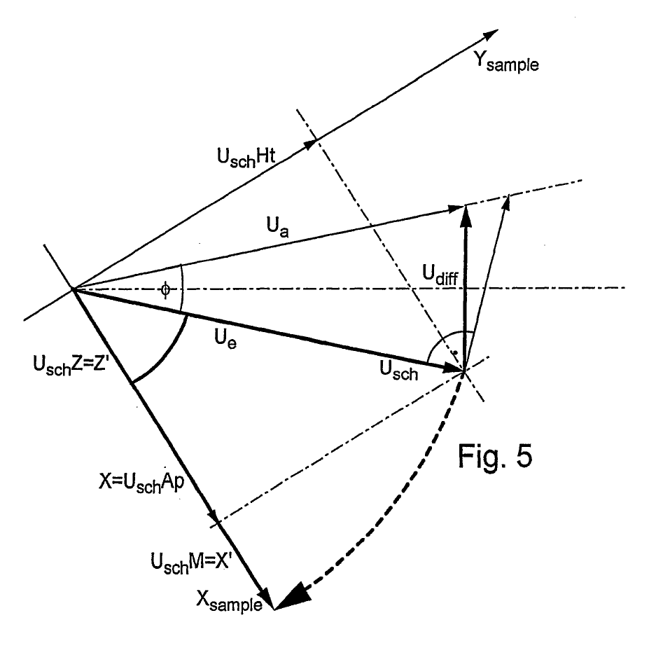

FIG. 5 a phasor diagram, which shows oscillation amplitude and phase according to Approach b).

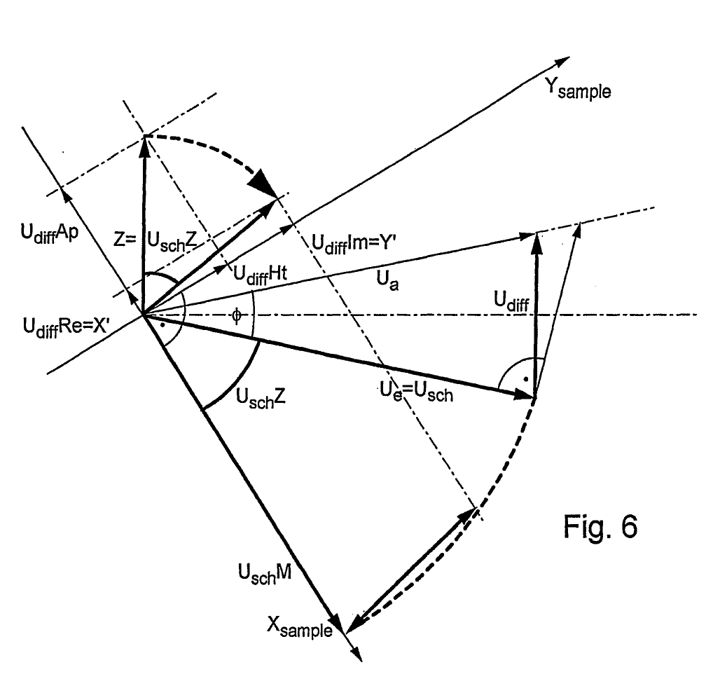

FIG. 6 a phasor diagram, which shows the projection of the difference signal according to Approach b);

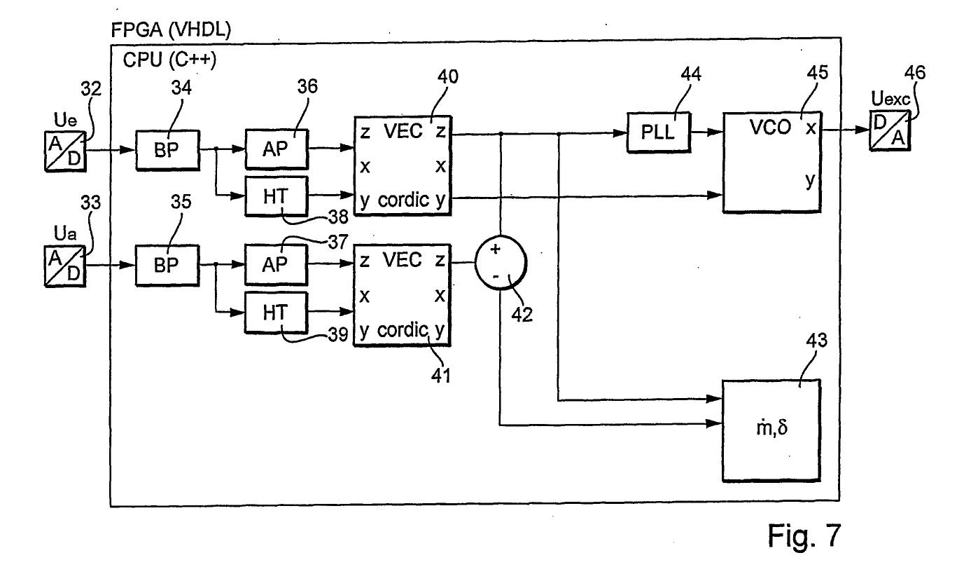

FIG. 7 a block diagram of a second advantageous embodiment (Approach c)) of the apparatus of the invention; and

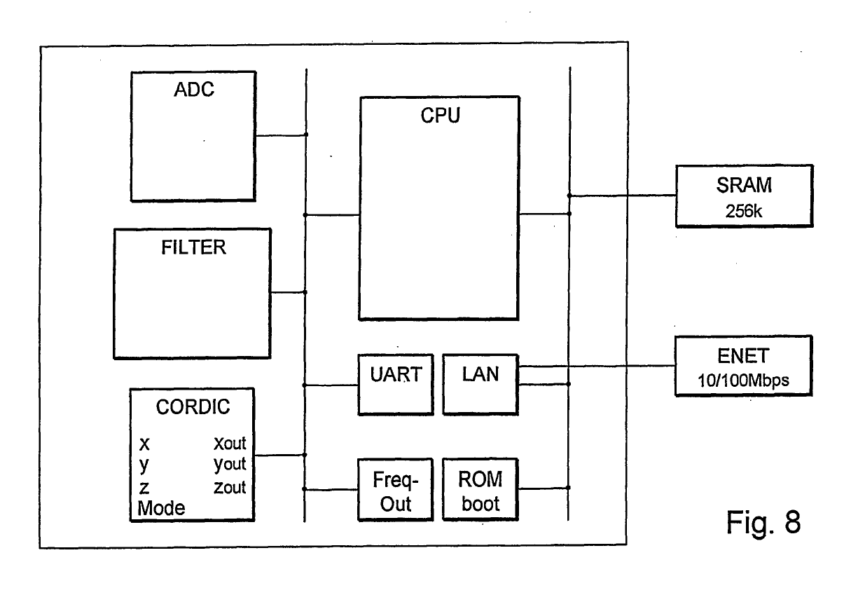

FIG. 8 a block diagram of a preferred implementation of the apparatus of the invention.

FIG. 1 is a schematic drawing of a Coriolis flow measuring device 1 of the invention, with a measuring tube 2, which, during use, is flowed-through by the medium 3, whose mass flow rate is to be determined. In the middle region of the measuring tube 2, an exciter system 4 is arranged, which excites the measuring tube 2 to oscillate at a predetermined resonance frequency. In the region of the inlet to the measuring tube 2, a first measured-value pickup 5 is provided, which delivers an entrance signal Ue. A second measured-value pickup 6 is arranged in the region of the outlet of the measuring tube 2 and provides an exit signal Ua. The control/evaluation unit 7 determines a phase shift, or a difference of the phase angles, between the entrance signal Ue and the exit signal Ua via a CORDIC algorithm and determines, on the basis of the calculated phase shift, or on the basis of the calculated phase angle difference, the mass flow rate, density and/or viscosity of the medium 3 flowing in the measuring tube 2.

FIG. 2 is a phasor diagram of the oscillation signal Usch and the difference signal Udiff. In the examples here, the entrance signal Ue is used as the oscillation signal Usch. From the two signals Ue, Ua, the mass flow rate through the measuring tube 2 of the Coriolis flow measuring device 1 is calculated. U.S. Pat. No. 4,914,956 teaches, in principle, how mass flow rate can preferably be calculated by means of a Coriolis flow measuring device 1:

From the entrance signal Ue and the exit signal Ua, the difference signal Udiff is formed, which contains the information concerning the phase shift evoked by the Coriolis effect.

The difference signal Udiff is shifted by 90° in phase.

The oscillation signal Usch is formed from the entrance signal Ue.

The integrated difference signal Udiff is divided by the sum signal, or the oscillation signal Usch, as the case may be. The corresponding output signal tan φ is directly proportional to the mass flow rate of the medium 3 through the measuring tube 2.

FIG. 3 shows a block diagram of a preferred embodiment of the Coriolis flow measuring device 1 of the invention. Especially Approach b) already described above comes into use in the case of this embodiment. The oscillation signal Usch and the difference signal Udiff are digitized by the two analog/digital converters 10, 11 and then filtered and amplified by the two bandpass filters 12, 13. For example, the filtering occurs in the range 700-900 Hz. It serves for suppressing interference signals. The amplification factor lies e.g. at 100 dB.

For determining the magnitude of the oscillation signal Usch, CORDIC block 31 is used in vectoring mode. To this end, an analytic, thus a complex, signal, must be fed to the CORDIC block. This complex signal is produced by the filtering of the now-digital signal Usch via the bandpass filter and the subsequent filtering of the signal via the Hilbert/allpass filters 16, 14. Analogously, the now-digital difference signal Udiff is filtered via the bandpass filter 13 and subsequently via the Hilbert/allpass filters 17, 15. Via the filterings, the real oscillation signal Usch and the real difference signal Udiff are both transformed to complex signals.

The phasor diagrams of FIGS. 4 and 5 visualize this so-called analytic signal projection and the determining of the angle Uschz according to Approach b): By the sampling, projections of the oscillation signal Usch and the difference signal Udiff onto the real axis X are obtained (UschAP, UdiffAP); by the allpass-Hilbert transformation, projections of the oscillation signal Usch and the difference signal Udiff onto the imaginary axis Y are obtained (UschHT, UdiffHT).

In order to determine the exact mass flow rate of the medium 3 through the measuring tube 2, the magnitudes, or the real part of the oscillation signal UschAP and the imaginary part of the difference signal UdiffHT must be brought into a synchronous position. To this end, the difference signal Udiff is rotated by 90°. This subject matter is illustrated on the basis of the phasor diagram visualized in FIG. 6. In the case of a complex signal, this phase displacement occurs by simple switching of the X and Y inputs at the CORDIC block 18. As a consequence, the X input of the difference signal CORDIC-block 18 is fed with the Hilbert component of the difference signal Udiff, while the Y input is fed with the allpass component. The allpass filters 14, 15 are responsible for assuring that the corresponding signal components have the same delay as the components which are fed via the Hilbert filters 16, 17.

If the analog amplification of the raw signals does not occur optimally, then the phase positions of the oscillation signal Usch and the difference signal Udiff will not yet agree following the 90° rotation of the difference signal Udiff. Therefore, it is necessary to operate the difference signal CORDIC-block 18 in the rotation mode and to rotate the difference signal by the current phase of the oscillation signal. In this way, the coordinate system of the difference signal is brought into the phase position of the oscillation signal. The remaining angle Z at the output of the difference-signal CORDIC-block 18 then corresponds to the symmetry error. Instead of the angle Z, also the real part of the difference signal at the output X can be used, referenced to the coordinate system of the oscillation signal, in order to control the symmetry. The output Y of the CORDIC-block 18 of the difference signal then shows exactly the imaginary part of the difference signal referenced to the coordinate system of the oscillation signal. This is used, together with the magnitude of the oscillation signal, for calculating mass flow rate.

The branch in the lower part and in the right upper part of the block diagram (A/D converter 26, allpass/Hilbert filters 28, 29, the CORDIC block 30, the PLL 20, the VCO 21, the PI-controller 22 and the D/A converter 23) relates to control of the oscillation frequency of the exciter system 4. Especially, the PI-controller cares for keeping the amplitudes of the entrance signal Ue and exit signal Ua of equal size.

FIG. 7 is a block diagram of a second advantageous embodiment (Approach c)) of the Coriolis flow measuring device 1 of the invention. The entrance signal Ue and the exit signal Ua are digitized by the two analog/digital converters 32, 33, without summing or difference forming, and subsequently filtered and amplified via the two bandpass filters 34, 35. Thereafter, then each of the two signals Ue, Ua can be handled separately.

The two CORDIC blocks 40, 41 are operated in the vectoring mode and determine the current phase position and magnitude of each of the two oscillation signals Ue, Ua. Since the two CORDIC blocks 40, 41 are capable of resolving the phase positions of the signals to any degree of accuracy, the two Z-results of the CORDIC blocks 40, 41 can be used directly for computing the desired variable of the medium 3. Especially, the difference of the two phase positions is directly proportional to the sought mass flow rate. Additionally, the angle increment of a signal is proportional to frequency and, thus, to the sought density.

The magnitudes of the signals, which, so-to-say, are delivered as by-products of the CORDIC blocks 40, 41, can be used for amplitude control. Since the phase positions of the signals are known, the frequency control can be implemented very simply. In order that this form of embodiment of a Coriolis flow measuring device 1 can deliver the desired accuracy of measurement, care must be taken that the analog frontend works phase-true to a high degree. This can be accomplished e.g. by the use of a single A/D converter working in multiplex operation.

FIG. 8 shows a block diagram of an implementation of the Coriolis flow measuring device 1 with A/D conversion, filtering, CORDIC block, a microprocessor and interfaces e.g. for the Internet.

### LIST OF REFERENCE CHARACTERS

1 flow measuring device

2 measuring tube

3 medium

4 exciter system

5 measured value pickup

6 measured value pickup

7 control/evaluation unit

8 housing

9 support system

10 A/D converter

11 A/D converter

12 bandpass

13 bandpass

14 allpass

15 allpass

16 Hilbert filter

17 Hilbert filter

18 CORDIC block

19 output of measured value

20 PLL

21 VCO

22 PI controller

23 D/A converter

24 D/A converter

25 D/A converter

26 A/D converter

27 bandpass

28 allpass

29 Hilbert filter

30 CORDIC block

31 CORDIC block

32 A/D converter

33 A/D converter

34 bandpass

35 bandpass

36 allpass

37 allpass

38 Hilbert filter

39 Hilbert filter

40 CORDIC block

41 CORDIC block

42 difference-taker

43 calculating unit

44 PLL

45 VCO

46 D/A converter

1-5. (canceled)

6. A coriolis flow measuring device used with at least one measuring tube having an inlet and an outlet, said coriolis flow measuring device comprising:
an exciter system, which causes the at least one measuring tube flowed-through by a medium to vibrate;
a first measured-value pickup, which is provided in the region of the inlet of the measuring tube and which outputs an entrance signal;
a second measured-value pickup, which is arranged in the region of the outlet of the measuring tube and which outputs an exit signal; and
a control/evaluation unit, which determines via a CORDIC algorithm a phase displacement, or a difference of the phase angles, between the entrance signal and the exit signal and which, on the basis of the calculated phase shift, or on the basis of the calculated phase angle difference, determines mass flow rate, density and/or viscosity of the medium flowing in the measuring tube.

7. The device as claimed in claim 6, wherein:
said control/evaluation unit determines the phase displacement between the entrance signal and the exit signal on the basis of the quotient formed of the sum signal, or the oscillation signal, and the difference signal, of the entrance signal and the exit signal.

8. The device as claimed in claim 7, wherein:
said control/evaluation unit determines the phase displacement between the entrance signal and the exit signal via a quadrature modulation of the oscillation signal.

9. The device as claimed in claim 7, wherein:
said control/evaluation unit determines the phase displacement between the entrance signal and the exit signal via a vectoring of the oscillation signal and a rotation of the difference signal.

10. The device as claimed in claim 7, wherein:
said control/evaluation unit determines the phase position of the entrance signal and the phase position of the exit signal on the basis of a vectoring of the entrance signal and a vectoring of the exit signal, and the mass flow rate, density and/or viscosity of the medium on the basis of the difference between the two determined phase positions.
